(19) United States
(12) Patent Application Publication
(10) Pub. No.: US 2015/0107350 A1
(43) Pub. Date: Apr. 23, 2015

(54) AUTONOMOUS MEASUREMENT OF THE INITIAL VELOCITY OF AN OBJECT THAT CAN BE FIRED

(71) Applicant: BAE Systems Bofors AB, Karlskoga (SE)

(72) Inventors: Erik Fohrman, Karlskoga (SE); Tony Holm, Degerfors (SE)

(21) Appl. No.: 14/402,439

(22) PCT Filed: May 15, 2013
(86) PCT No.: PCT/SE2013/000072

§ 371 Date: Nov. 20, 2014

(30) Foreign Application Priority Data
May 21, 2012 (SE) 1230050-5

(51) Int. Cl. G01P 3/66

(52) U.S. Cl. CPC G01P 3/665
USPC 73/167

(57) ABSTRACT

The invention concerns a process for measuring the initial velocity V₀ of an object that can be fired such as a shell or projectile that exits a barrel, said measurement being based on measurement of the force exerted on a sensor device (100) configured inside the object that can be fired, characterized in that the force is measured autonomously inside the object by detection of changes in shape of the sensor device (100) during movement of said object inside the barrel prior to its exit. The invention also concerns a device for measuring the initial velocity V₀ of an object that can be fired such as a shell or projectile that exits the barrel of a firing device such as an artillery piece, comprising a force-detecting sensor device (100) configured inside the object that can be fired, characterized in that the force-detecting sensor device (100) is configured so as to detect changes in shape of said sensor device (100) during movement of said object inside the barrel prior to its exit, and in that an included signal-processing unit calculates and determines the initial velocity V₀ based on the detected changes in shape. The invention also concerns a device and process for measuring the acceleration forces acting on an object that can be fired during movement of said object inside the barrel prior to its exit.

The invention concerns a process for measurement of the initial velocity V₀ of an object that can be fired such as a shell or projectile that exits a barrel, said measurement being based on measurement of the force exerted on a sensor device configured inside the object that can be fired. The invention also concerns a device for measuring the initial velocity V₀ of an object that can be fired such as a shell or projectile. Furthermore, the invention also concerns a device and process for measuring the acceleration forces acting on the object that can be fired during movement of said object inside the barrel prior to its exit.

The initial velocity of a projectile, often referred to as initial velocity or V₀, refers to the velocity of the projectile or other object that can be fired during movement of said projectile prior to exiting the firing device from which it is propelled or fired in any other manner. Initial velocity is determined by a number of factors related to the projectile's shape, the shape of the firing device, and the propellant used to accelerate the projectile inside the firing device. The firing device should preferably be a gun comprising a barrel. The projectile is accelerated inside the barrel, and factors such as friction of the projectile against the wall of the barrel and wear and tear on the barrel affect initial velocity. The propellant, which is often some form of gunpowder, also causes acceleration of the object. Factors such as ambient temperature, ignition of the propellant, and the manner in which the propellant is packed may also affect initial velocity. Knowledge of initial velocity is important in order to improve precision in striking the intended target of the projectile. For example, if the projectile is intended to strike a target at a known range, the projectile is programmed with data on this range before being fired. As the projectile exits the barrel, its initial velocity is measured, and this measurement can then be used to calculate the time to impact at the target. When the projectile has travelled for the calculated amount of time, it explodes, at which point it is in the vicinity of the target.

A number of methods for calculating velocity by means of an accelerometer contained inside a projectile are known in prior art, cf. Published U.S. Pat. No. 2006/0169833 A1 and U.S. Pat. No. 6,779,752 B1, both of which describe methods and navigation systems for projectiles whose velocity is determined by means of an accelerometer in combination with a GPS receiver. The methods and navigation systems described in U.S. Pat. No. 2006/0169833 A1 and U.S. Pat. No. 6,779,752 B1 are not suitable for measuring initial velocity, as information cannot be obtained from a GPS system at the time the projectile exits the barrel because of the time required for a GPS system to locate the projectile and read the data via positioning satellites. The accuracy of velocity determination with a GPS receiver is not sufficient to meet the requirements for determining initial velocity.

Methods involving the use of accelerometers in the form of bridge-type resistors for calculating velocity are known, for example, from U.S. Pat. No. 5,456,109, in which a bridge-type resistor composed of a thick film in combination with discrete components is described. The bridge-type resistor described in said U.S. Pat. No. 5,456,109 is intended to be used for measuring linear acceleration and angular acceleration, and the resistors described are of the piezoelectric type and are mounted on a thick film substrate. The accelerometer described in U.S. Pat. No. 5,456,109 is not designed for integration into a projectile and is therefore unsuitable for measurement of the forces that occur in the electronic components of a projectile.

Methods and devices for determination of initial velocity by calculating rotation based on sensor data from a magnetometer are described, for example, in U.S. Pat. No. 6,345,785 B1 and U.S. Pat. No. 6,484,115 B1. Measurement results from a magnetometer are affected by the elevation, firing direction, and global localization of the firing device, and the methods and devices described in U.S. Pat. No. 6,345,785 B1 and U.S. Pat. No. 6,484,115 B1 therefore show poor accuracy and limited scope of application.

The drawbacks and limitations of existing or proposed technology and/or methods are improved on and solved by the present novel invention.

One object of the present invention is to propose a method for autonomous determination of initial velocity with a high degree of accuracy.

Other objects of the invention are described in more detail in connection with the detailed description of the invention.

The invention concerns a process for measuring the initial velocity V₀ of an object that can be fired such as a shell or projectile that exits a barrel, said measurement being based on measurement of the force exerted on a sensor device configured inside the object that can be fired, wherein the force is measured autonomously inside the object by detection of changes in shape of the sensor device during movement of said object inside the barrel prior to its exit.

Further embodiments of the improved process for measuring initial velocity are as follows:

the change in shape of the sensor device is measured based on changes in the resistance of said sensor device.
the change in shape of the sensor device is measured based on changes in the resistance of at least one electrical conductor configured in the sensor device.
the change in shape of the sensor device is measured based on changes in the resistance of at least one electrical conductor configured in the sensor device, with said electrical conductor being a conducting channel in a doped semiconductor material.
information on detected changes in shape is used to determine the angular acceleration of the object around a rotational axis in the direction of the object's trajectory.
information on detected change in shape is used to determine the axial acceleration of the object in the direction of the object's trajectory.
the information on detected changes in shape is derived from a voltage based on change in shape generated by the sensor device.
information on detected changes in shape is derived from a current based on change in shape generated by the sensor device.
information on detected changes in shape is derived from a frequency based on change in shape generated by the sensor device.
angular acceleration is measured by detection of bending X in at least one sensor body in the sensor device configured inside the object, and V₀ is determined as a value proportional to the angular acceleration measured when the rotation of the object shows a constant value for several successive measurement points. The term constant value refers to measurement of at least two successive identical values or values assessed to be identical within the accuracy of the sensor device.
the initial velocity V₀ is determined according to the following equation:

V₀=k·X₀·T·d

where k is a constant, X₀ denotes bending when rotation shows a constant value for several successive measurement points and indicates the object's rotation, T denotes barrel twist rate, and d denotes the distance of the sensor from the rotation centre.
the values for bending of the ingoing sensor body are averaged.
the point in time when the object that can be fired passes the muzzle of the barrel is calculated from information on detected change in shape in order to determine the object's axial acceleration in the firing direction via a voltage based on change in shape generated by the sensor device.
the point in time when the object that can be fired passes the muzzle of the barrel is calculated from information on detected change in shape in order to determine the object's axial acceleration in the firing direction via a current based on change in shape generated by the sensor device.
the point in time when the object that can be fired passes the muzzle of the barrel is calculated from information on detected change in shape in order to determine the object's axial acceleration in the firing direction via a frequency based on change in shape generated by the sensor device.

The invention also concerns a device for measuring the initial velocity V₀ of an object that can be fired such as a shell or projectile that exits the barrel of a firing device such as an artillery piece, comprising a force-detecting sensor device configured inside the object that can be fired, wherein the force-detecting sensor device is configured so as to detect changes in said sensor device during movement of said object inside the barrel prior to its exit, and an included signal-processing unit calculates and determines the initial velocity V₀ based on the detected changes in shape.

Further embodiments of the improved device for measuring initial velocity are as follows:

the change in shape of the sensor device generates resistance in at least one resistor configured in a sensor body.
the resistor is a conducting channel configured in a silicon substrate, and the resistance of the resistor is altered by change in shape of said conducting channel configured in the silicon substrate.
resistance is imparted to the conducting channel configured in the silicon substrate by doping of the silicon substrate.
the sensor device contains at least one sensor body whose bending depends on the angular acceleration of the object, and the contained signal-processing device, based on bending of the contained sensor bodies, calculates the rotation of the object and determines the initial velocity V₀ as a value proportional to angular acceleration when the angular acceleration of the object shows a constant value at several consecutive measurement points.
the sensor device contains at least one sensor body whose bending depends on the angular acceleration of the object in the firing direction.
the sensor device comprises a plurality of sensor bodies.
the sensor device comprises three or four sensor bodies.
the sensor bodies are configured according to MEMS technology.
the object that can be fired contains a transmitter for sending the measured initial velocity V₀ to a receiver connected to the firing device.
the ingoing sensor bodies comprise an electric bridge-type coupling having a first branch with two force-independent resistors connected in series and a second branch with two force-dependent resistors connected in series, wherein the first and second branches are connected to a voltage source, and in that a voltage sensor is connected between the series-coupled resistor of the first branch and the series-coupled resistor of the second branch in order to measure a force-dependent output voltage as a basis for determining the firing acceleration values of the object.
the ingoing sensor bodies comprise an electrical bridge-type coupling configured as a Wheatstone bridge with force-independent or force-dependent resistors, wherein the bridge-type coupling is supplied with a voltage source, or changes in current and changes in voltage resulting from changes in shape acting on the bridge-type coupling can be measured from the output of said bridge-type coupling.
the bridge-type coupling is configured on a common silicon surface.
the silicon surface is configured with an outlet for control of the shape-changing forces on the sensor body.

The invention also concerns a process for measuring the acceleration forces acting on an object that can be fired such as a shell or a projectile in a barrel, said measurement being based on measurement of the force exerted on a sensor device configured inside the object that can be fired, wherein the force is measured autonomously inside the object by detection of changes in shape of the sensor device during movement of said object inside the barrel prior to its exit.

Further embodiments of the improved process for measuring acceleration forces are as follows:

the change in shape of the sensor device is measured based on changes in the resistance of said sensor device.
the change in shape of the sensor device is measured based on changes in the resistance of at least one electrical conductor configured in the sensor device.
the change in shape of the sensor device is measured based on changes in the resistance of at least one electrical conductor configured in the sensor device, with said electrical conductor being a conducting channel in a doped semiconductor material.
information on detected changes in shape is used to determine the angular acceleration of the object around a rotational axis in the longitudinal direction of the barrel.
information on detected change in shape is used to determine the axial acceleration of the object in the longitudinal direction of the barrel.
information on detected change in shape is used to determine the radial acceleration of the object in the radial direction of the barrel.

The invention also concerns a device for measuring the acceleration forces acting on an object that can be fired such as a shell or projectile during movement of said object inside the barrel prior to exiting a firing device such as an artillery piece, comprising a force-detecting sensor device configured inside the object that can be fired, wherein the force-detecting sensor device is configured so as to detect changes in said sensor device during movement of said object inside the barrel prior to its exit, and an included signal-processing unit calculates and determines the acceleration forces based on the detected changes in shape.

Further embodiments of the improved device for measuring acceleration forces are as follows:

the change in shape of the sensor device generates resistance in at least one resistor configured in a sensor body.
the resistor is a conducting channel configured in a silicon substrate, and the resistance of the resistor is altered by change in shape of the conducting channel configured in the silicon substrate.
resistance is imparted to the conducting channel configured in the silicon substrate by doping of the silicon substrate.

In the following, the invention will be described in further detail with reference to the attached figures, in which:

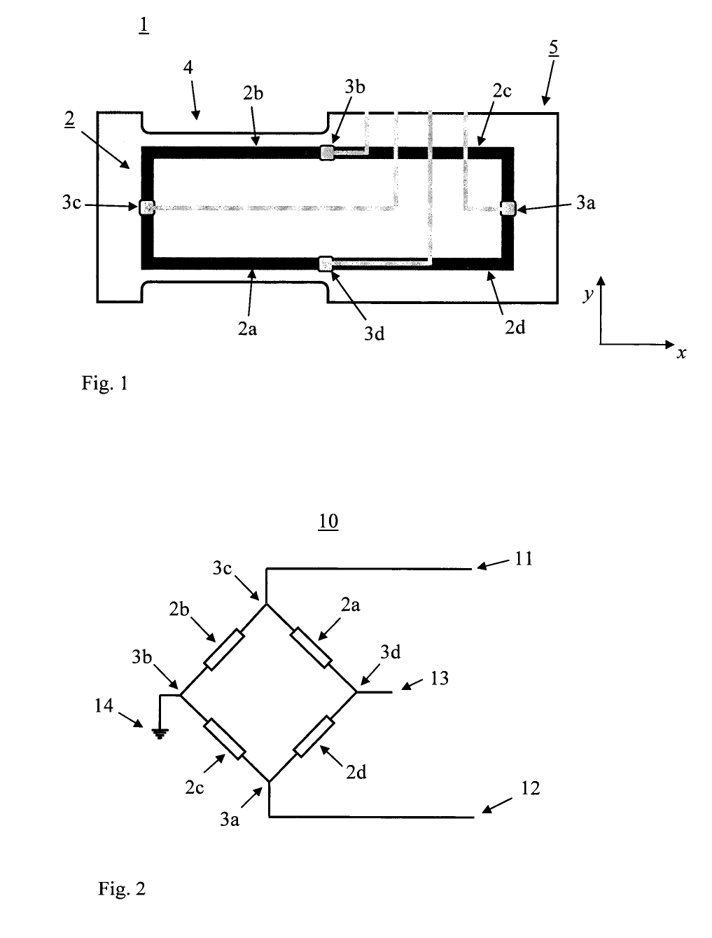

FIG. 1 shows the sensor body for measuring acceleration forces according to the invention.

FIG. 2 shows a circuit diagram for measuring acceleration forces according to the invention.

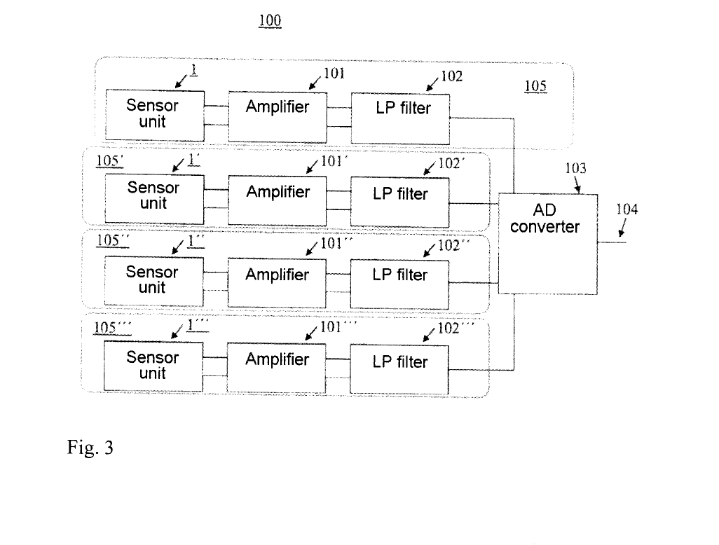

FIG. 3 shows a block diagram of the sensor device for measuring acceleration forces according to the invention.

FIG. 1 shows a sensor body 1, also referred to as a sensor unit, for measuring acceleration forces according to the invention. The sensor body 1 is preferably configured as a silicon substrate 5 wherein four resistors 2a, 2b, 2c, and 2d are connected in an electrical circuit. The sensor body 1 can also be configured according to MEMS technology or another micromechanical configuration, or as a printed circuit board or according to thin-film technology or thick-film technology. The resistors are connected in series, and a number of electrical coupling points 3a, 3b, 3c, and 3d are configured in the electrical circuit 2. The electrical circuit 2, which is a part of the sensor body 1, should preferably be a so-called Wheatstone bridge, and because of its configuration, it is suitable for detecting extremely small variations in resistance of the resistors 2a, 2b, 2c, and 2d of the electrical circuit 2. The configuration shown in FIG. 1 also has a symmetrical outlet 4 configured in the silicon substrate 5. The outlet functions as an indicator, attenuator, or controller so that the forces acting on and encumbering the sensor body 1 and thus the silicon substrate 5 are able to act on the silicon substrate and change its shape. The action on or encumbrance of the silicon substrate 5 during acceleration of the sensor body 1 is caused by compressing, twisting, and shearing forces acting on said substrate, and other forces may also arise.

A common characteristic of the forces acting on the silicon substrate is that they change the shape of said substrate. The shape-changing forces acting on the silicon substrate 5 generate resistance in one or more of the resistors 2a, 2b, 2c, or 2d configured on the silicon substrate 5. Preferably, resistors 2a and 2b should be force-dependent, and resistors 2c and 2d should be force-independent. A force-dependent resistor changes its value in response to shape-changing forces, while a force-independent resistor shows constant resistance even when it is exposed to shape-changing force. Resistors 2a, 2b, 2c, or 2d should preferably be mounted on the silicon substrate 5 or be configured as a part of the silicon substrate 5, for example in an arrangement in which the conducting material of the silicon substrate, i.e. the conducting channel, comprises the resistors. The resistors should preferably be configured by doping the silicon substrate, but they may also be configured in the form of various types of metals, piezoelectric materials, or polymers such as elastomers or combinations of various materials. The resistors may be configured so as to be force-dependent or force-independent, for example by carrying out doping by various methods or selecting various materials.

Physical change due to clockwise twisting of the silicon substrate 5 in the x-y plane, i.e. clockwise twisting around the z axis, results in the altered resistance values r₂ₐ′=r₂ₐ−Δr and r₂ₚ′=r_{2b}+Δr, where Δr is the change in resistance. In the same manner, a counterclockwise change in the silicon substrate in the x-y plane, i.e. counterclockwise twisting around the z axis, results in the altered resistance values r₂ₐ′=r₂ₐ+Δr and r_{2b}′=r_{2b}−Δr, where Δr is the change in resistance. In the same manner, clockwise twisting of the silicon substrate in the z-x plane, i.e. clockwise twisting around the y axis, results in the altered resistance values r₂ₐ′=r₂ₐ+Δr and r_{2b}′=r_{2b}+Δr, where Δr is the change in resistance. In the same manner, counterclockwise twisting of the silicon substrate in the x-z plane, i.e. counterclockwise twisting around the y axis, results in the altered resistance values r₂ₐ′=r₂ₐ−Δr and r_{2b}′=r_{2b}−Δr, where Δr is the change in resistance. In the same manner, clockwise twisting of the silicon substrate in the z-y plane, i.e. clockwise twisting around the x axis, results in the altered resistance values r₂ₐ′=r₂ₐ+Δr and r_{2b}′=r_{2b}+Δr, where Δr is the change in resistance. In the same manner, counterclockwise twisting of the silicon substrate in the z-y plane, i.e. counterclockwise twisting around the x axis, results in the altered resistance values r₂ₐ′=r₂ₐ−Δr and r_{2b}′=r_{2b}−Δr, where Δr is the change in resistance.

By means of mathematical derivation, it is possible to show that if twisting occurs in the x-y plane of the silicon substrate, there is a change in the electric discharge voltage, Vₒᵤₜ, that is directly proportional to the physical changes in the silicon substrate. In the same manner, it is possible to show that if twisting occurs in the x-z or y-z plane of the silicon substrate, there is a change in the electric currents in the circuit that is directly proportional to the physical changes in the silicon substrate. The measured physical changes, changes in shape, are used to calculate the angular acceleration and axial acceleration. The rotation of the object can be calculated from the angular acceleration, and its velocity can be calculated from the axial acceleration. The initial velocity V₀ is determined according to the following equation:

V₀=k·X₀·T·d

where k is a constant, X₀ denotes bending when rotation shows a constant value for several successive measurement points and indicates the object's rotation, T denotes barrel twist rate, and d denotes the distance of the sensor from the rotation centre. It is possible to determine both rotation speed and speed in the axial direction by using information on detected changes in shape to determine the object's angular acceleration around a rotation axis in the direction it is fired, and by using information on detected change in shape to determine the object's axial acceleration in the direction it is fired.

As an alternative, the measured acceleration forces can be used to determine data on the object that can be fired during movement of said object inside the barrel prior to its exit. Angular acceleration, acceleration with respect to axial movement of the object inside the barrel, and acceleration with respect to radial movement of the object inside the barrel are examples of acceleration forces that can be determined for the object. The measured forces can be stored in the object that can be fired or transmitted from said object. The measured forces can also be used to determine wear and tear on the barrel or modify the forces acting on the object that can be fired.

Moreover, the object that can be fired may also include a transmitter for sending information on the measured initial velocity to the firing device or a receiver for receiving data on the measured initial velocity from the firing device in order to calibrate the initial velocity measured internally in said object.

FIG. 2 shows a circuit 10 in which the sensor body 1, also referred to as the sensor unit, is electrically coupled to the calculation unit of the signal processing unit of the object that can be fired. The resistors 2a, 2b, 2c, and 2d are shown as discrete components in the circuit diagram. Concerning the physical configuration of the sensor unit, the resistors may be discrete, in the form of detachable components, or distributed in the form of a printed circuit board or conducting channel on a silicon substrate. The resistors are connected via four coupling points 3a, 3b, 3c, and 3d. Electrical conductors are connected to the coupling points. Coupling point 3b is connected to an electrical ground, and in a projectile, it is often configured as a ground plan, ground point, or negative potential on the projectile's battery or other energy-supplying device. Coupling point 3d is connected to the electrical conductor 13 that is preferably coupled to a constant electrical potential Vᵢₙ, input voltage. The input voltage may be varied by means of configuration of the sensor body 1 or the object that can be fired or varied in the case of actual firing or other factors that may affect the course of such firing. Between conductors 11 and 12, which are connected to coupling points 3a and 3c, one obtains the electrical output signal Vₒᵤₜ. The electrical output signal is in turn transmitted to a signal processing unit contained in the object that can be fired. Coupling is carried out differentially in order to improve the quality of the signal-to-noise ratio.

Alternatively, the coupling point 3d attached to the electrical conductor 13 can also be coupled to an oscillating circuit having a variable voltage Vᵢₙ, i.e. the input voltage. The input voltage can be varied based on the configuration of the sensor body 1 or the object that can be fired or varied in the case of actual firing or other factors that may affect the course of such firing if measurement of frequency or phase is preferred over measurement of current or voltage. Between conductors 11 and 12, which are connected to coupling points 3a and 3c, one obtains the electrical output signal Vₒᵤₜ. The electrical output signal is in turn transmitted to a signal processing unit contained in the object that can be fired. Coupling is carried out differentially in order to improve the quality of the signal-to-noise ratio. If the input voltage Vᵢₙ is a variable-frequency voltage, the output signal Vₒᵤₜ will be a variable-frequency output voltage. By measuring the change in frequency when the silicon substrate is deformed, it is possible to determine the extent of such deformation.

FIG. 3 shows a sensor device 100, also referred to as a measuring system, for measuring acceleration forces. The sensor device 100 consists of a number of force-detecting sensor bodies 1, 1′, 1″, and 1′″ for measuring acceleration. The sensor device 100 further consists of a number of amplifiers 101, 101′, 101″, and 101′″ and a number of low-pass filters 102, 102′, 102″, and 102′″. The sensor device 100 shown consists of four channels 105, 105′, 105″, and 105′″. Preferably, the sensor device 100 has three or four channels 105, 105′, 105″, and 105′″, but it may also consist of a larger or smaller number of channels. Each of the channels 105, 105′, 105″, and 105′″ contains a force-detecting sensor body 1, 1′, 1″, 1′″, an amplifier 101, 101′, 101″, 101′″ and a low-pass filter 102, 102′, 102″, and 102′″. One channel 105 is coupled to an amplifier 101 via one of the sensor bodies 1. The electrical coupling should preferably be differential, but may also be of another type. The electrical amplifier 101 is suitably placed in the vicinity of the sensor body 1 in order to minimize the effect of electrical interference. After the signal from the sensor body 1 is electrically amplified in the electrical amplifier 101, the signal is electrically coupled to a low-pass filter, LP-filter 102, for electrical filtering of the signal from the amplifier 101. The electrical low-pass filter 102 filters out electrical high-frequency interference from the electrically amplified signal from the sensor body 1. The output signal from the low-pass filter 102, which is an electrically amplified and low-pass filtered signal from the sensor body 1, is coupled to an analog-to-digital converter 103. Channel 105′, containing sensor body 1′, amplifier 101′, and low-pass filter 102′, channel 105″, containing sensor body 1″, amplifier 101″, and low-pass filter 102″, and channel 105′″, containing sensor body 1″′, amplifier 101′″, and low-pass filter 102′″ are configured in the same manner. The analog-to-digital signal converter, AD converter 103, converts the analog signal from low-pass filters 102, 102′, 102″, and 102′″ into a digital signal. The digital signal 104 from the AD converter 103 should preferably be a 16-bit signal, but may also consist of digital data comprising a different number of bits or other signal levels. The AD converter 103 is limited by the number of channels, i.e., the number of parallel routes for the number of signals that can be converted in parallel. The AD converter should preferably have 8 parallel channels. By using several of channels 105, 105′, 105″, and 105′″, the values measured via the sensor bodies 1 can be averaged or combined in another manner in order to more precisely measure the acceleration forces. The digital output signal 104 from the AD converter 103 is further coupled to the electronic system in the object that can be fired in order to calculate the rotational acceleration and/or rotation speed and/or linear acceleration and/or velocity of the projectile along its firing direction. A signal processing unit processes the digital output signal 104 from the sensor body 1 and sensor device 100. The signal processing unit calculates axial speed and/or rotation speed based on values measured by the sensor body 1 and sensor device 100.

The digital output signal is composed of information on changes in the resistance value in the sensor body of the respective channel. The acceleration in the object that can be fired can be determined by means of previous values registered in the signal processing unit, values for which acceleration corresponds to a certain resistance. The changes in resistance measured in the object that can be fired are compared with the registered values in order to determine that the acceleration corresponds to a certain measured change in resistance. The signal processing unit can combine values from several channels 105, 105′, 105″, and 105′″ in order to determine an average acceleration value.

The signal processing unit is further coupled to the electronic system in the mobile object in order to calculate the time to explosion or other required calculations. The sensor device 100 may also be used in order to detect and measure positional changes in the object that can be fired while the object is moving inside the barrel, e.g. in order to measure parameters detected with respect to the object inside the barrel, also referred to as “clatter.” Furthermore, the sensor device may be used in order to measure changes in the trajectory of the object due to effects exerted on the object by factors such as turbulence, aerodynamic deviations, or other forces acting on the object. The sensor device may also be used in order measure the object that can be fired as it exits the muzzle, as knowledge of the time at which the object exits the muzzle increases its accuracy.

The invention is not limited to these specified embodiments, but may be modified in various ways within the scope of the patent claims.

It can be seen that the above-described method for determining the initial velocity and/or the device for determining said initial velocity may be applied in principle to any objects that can be fired, such as projectiles, missiles, or shells. The invention may also be used in other contexts in order to determine the acceleration or velocity of vehicles, for example, or other crafts, regardless of their application or size.

1. A process for measurement of the initial velocity V₀ of an object that can be fired that exits a barrel, said measurement being based on measurement of a force exerted on a sensor device configured inside the object that can be fired, wherein said force is measured internally in the object by detection of physical change in shape of the sensor device during movement of said object inside the barrel prior to its exit, wherein the physical change in shape of the sensor device is measured based on the change in resistance in the sensor device.

2. The process according to claim 1, wherein the physical change in shape of the sensor device is measured based on the change in resistance of a least one electrical conductor configured in the sensor device.

3. The process according to claim 1, wherein the physical change in shape of the sensor device is measured based on the change in resistance of a least one electrical conductor configured in the sensor device, said electrical conductor being a conducting channel in a doped semiconductor material.

4. Process according to claim 1, wherein information on detected physical change in the shape of the sensor device is used to determine the angular acceleration of the object in the firing direction.

5. Process according to claim 1, wherein information on detected physical change in shape of the sensor device is used to determine the axial acceleration of the object in the firing direction.

6. (canceled)

7. (canceled)

8. (canceled)

9. (canceled)

10. Process according to claim 1, wherein the initial velocity V₀ is determined according to the following equation:
V₀=k·X₀·T·d
where k is a constant, X₀ denotes bending when rotation shows a constant value for several successive measurement points and indicates the object's rotation, T denotes barrel twist rate, and d denotes the distance of the sensor from the rotation centre.

11. (canceled)

12. (canceled)

13. (canceled)

14. (canceled)

15. A device for measuring the initial velocity V₀ of an object that can be fired that exits the barrel of a firing device, comprising a force-detecting sensor device configured inside the object that can be fired, wherein the force-detecting sensor device is configured so as to detect physical changes in the shape of the sensor device during movement of said object inside the barrel prior to its exit, and in that an included signal-processing unit calculates and determines the initial velocity V₀ based on the detected physical change in shape, wherein physical change in shape generates resistance in at least one resistor configured in a sensor body.

16. The device according to claim 15, wherein the resistor is a conducting channel configured in a silicon substrate, and the resistance of the resistor is altered by physical change in shape of the conducting channel configured in said silicon substrate.

17. (canceled)

18. (canceled)

19. The device according to claim 15, wherein the sensor device contains at least one sensor body whose bending depends on the angular acceleration of the object in the firing direction.

20. The device according to claim 18, wherein the sensor device comprises a plurality of sensor bodies.

21. (canceled)

22. The device according to claim 15, wherein the sensor bodies are configured according to MEMS technology.

23. The device according to claim 15, wherein the object that can be fired contains a transmitter for sending the measured initial velocity V₀ to a receiver connected to the firing device.

24. (canceled)

25. (canceled)

26. The device according to claim 15, wherein the bridge-type coupling is configured on a common silicon surface.

27. (canceled)

28. A process for measuring the acceleration forces acting on an object that can be fired such as a shell or a projectile in the barrel, said measuring being based on measurement of the force exerted on a sensor device configured inside the object that can be fired, wherein the force is measured autonomously inside the object by detection of physical change in shape of the sensor device during movement of said object inside the barrel prior to its exit, wherein physical change in the shape of the sensor device is measured based on changes in the resistance of the sensor device.

29. The process according to above claim 28, wherein physical change in shape of the sensor device is measured based on changes in the resistance of at least one electrical conductor configured in the sensor device.

30. (canceled)

31. The process according to claim 28, wherein information on detected physical change in shape of the sensor device is used to determine the angular acceleration of the object around a rotational axis in the longitudinal direction of the barrel.

32. The process according to claim 28, wherein information on detected physical change in shape of the sensor device is used to determine the axial acceleration of the object around a rotational axis in the longitudinal direction of the barrel.

33. (canceled)

34. A device for measuring the acceleration forces acting on an object that can be fired during movement of said object inside the barrel prior to exiting a firing device, comprising a force-detecting sensor device configured inside the object that can be fired, wherein the force-detecting sensor device is configured so as to detect physical change in said sensor device during movement of said object inside the barrel prior to its exit, and in that an included signal-processing unit calculates and determines the acceleration forces based on detected physical change in shape of the sensor device, wherein physical change in shape of said sensor device generates resistance in at least one resistor configured in a sensor body.

35. The device according to claim 34, wherein the resistor is a conducting channel configured in a silicon substrate, and in that the resistance of the resistor is altered by physical change in shape of the conducting channel configured in the silicon substrate.

36. The device according to claim 34, wherein resistance is imparted to the conducting channel configured in the silicon substrate by doping of the silicon substrate.
